(19) United States
(12) Patent Application Publication
(10) Pub. No.: US 2022/0379872 A1
(43) Pub. Date: Dec. 1, 2022

(54) ELECTRIFIED VEHICLE CONTROL WITH DISTRIBUTION OF POWERTRAIN TORQUE TO SECONDARY AXLE

(71) Applicant: FORD GLOBAL TECHNOLOGIES, LLC, Dearborn, MI (US)

(72) Inventors: Brian MORTON, Miami (AU); Robert David HANCASKY, Warren, MI (US); Jonathan Andrew BUTCHER, Farmington, MI (US)

(73) Assignee: FORD GLOBAL TECHNOLOGIES, LLC, Dearborn, MI (US)

(21) Appl. No.: 17/331,213

(22) Filed: May 26, 2021

(51) Int. Cl. B60W 20/15; B60W 10/08

(52) U.S. Cl. CPC B60W 20/15; B60W 10/08; B60W 10/06

(57) ABSTRACT

An electrified vehicle includes an engine configured to selectively apply propulsive torque to wheels of a first axle of the vehicle, a first electric machine configured to selectively apply propulsive torque to the wheels of the first axle of the vehicle, a second electric machine configured to selectively apply propulsive torque to wheels of a second axle of the vehicle, a traction battery electrically coupled to the first and second electric machines, and a controller configured to control engine torque, first electric machine torque, and second electric machine torque to provide a driver demand torque at the wheels of the first and second axles. The controller allocates torque between the first and second electric machines based on associated combined losses of the first and second electric machines and maintaining the torque of the first and second electric machines in the same direction.

### TECHNICAL FIELD

This disclosure relates to control of an electrified vehicle that efficiently allocates and distributes powertrain torque between primary and secondary axles.

### BACKGROUND

Electrified vehicles including hybrid electric vehicles (HEVs), plug-in hybrid electric vehicles (PHEVs) and battery electric vehicles (BEVs) may include multiple powertrain actuators that can be used to provide electric all-wheel drive (eAWD) functionality. Based on inputs from the driver, such as accelerator pedal position, a vehicle controller determines a total driver-demanded torque and controls the actuators to deliver the torque to the wheels for each axle. One or more primary powertrain actuators may provide propulsive powertrain torque to wheels of an associated primary axle and one or more secondary powertrain actuators may provide propulsive powertrain torque to wheels of an associated secondary axle. An eAWD system has the capability and flexibility to allocate and distribute torque between the primary and secondary axles to satisfy the driver-demanded torque. Because the losses generated by operating an electric motor vary as a function of speed and generated torque, control of the speeds and torques of the electric motors impacts engine fuel consumption and electric range of the vehicle. However, allocating torque based only on minimizing losses may result in applied torque having different directions for the front and rear axles under some operating conditions.

### SUMMARY

Embodiments of the disclosure include a vehicle having an engine configured to selectively apply propulsive torque to wheels of a first axle of the vehicle, a first electric machine configured to selectively apply propulsive torque to the wheels of the first axle of the vehicle, a second electric machine configured to selectively apply propulsive torque to wheels of a second axle of the vehicle, a traction battery electrically coupled to the first and second electric machines, and a controller configured to control engine torque, first electric machine torque, and second electric machine torque to provide a driver demand torque at the wheels of the first and second axles, wherein the controller allocates torque between the first and second electric machines based on associated combined losses of the first and second electric machines and maintaining the torque of the first and second electric machines in the same direction. The controller may be further configured to control the second electric machine torque based on a difference between the driver demand torque and the engine torque, and to control the first electric machine torque based on the second electric machine torque. The controller may be further configured to retrieve a target value for the second electric machine torque from a lookup table stored in memory accessible by the controller and indexed based on a total electric machine torque, the total electric machine torque corresponding to a difference between the driver demand torque and the engine torque. The controller may be further configured to control the first electric machine torque based on a difference between the total electric machine torque and the target value for the second electric machine torque. The lookup table may include only target values greater than zero.

In various embodiments, the vehicle includes a transmission having a plurality of gears connecting both the engine and the first electric machine to the first axle. The vehicle may also include a planetary gear set connecting the engine to the transmission, wherein the engine torque is adjusted based on a torque ratio of the planetary gear set. The vehicle may include a third electric machine connected to the first axle by the planetary gear set and electrically connected to the traction battery.

Embodiments may include a system having a first electric machine configured to provide torque to at least one wheel of a primary axle, a second electric machine configured to provide torque to at least one wheel of a secondary axle, and a controller programmed to control torque of the first and second electric machines to deliver a driver demand torque to at least one of the primary and secondary axle wheels based on combined power loss associated with torque delivered by the first and second electric machines, wherein the torque delivered by the first and second electric machines is in the same direction. The controller may be further programmed to control the second electric machine to deliver torque greater than or equal to zero. The controller may be further programmed to control the second electric machine torque in response to a target value retrieved from a lookup table stored in memory accessibly by the controller, the lookup table indexed by the driver demand torque.

In various embodiments, the system includes an engine configured to deliver engine torque to the at least one wheel of the primary axle, wherein the controller controls the torque delivered by the first and second electric machines in response to a difference between the driver demand torque and the engine torque. The system may include a third electric machine, wherein the engine and the third electric machine are coupled to the at least one wheel of the primary axle through a planetary gear set. The controller may determine the driver demand torque in response to an accelerator pedal position, determine the second electric machine torque from a lookup table based on a difference between the driver demand torque and the engine torque, and determine the first electric machine torque based on the second electric machine torque and the difference between the driver demand torque and the engine torque.

Embodiments may also include a method performed by a vehicle controller that includes controlling torque delivered by an engine and first and second electric machines to wheels of a first and second axle to meet a driver demand torque such that torque delivered by the first and second electric machines is allocated based on torque-related losses of the first and second electric machines, and such that the torque delivered by the second electric machine is greater than or equal to zero. The method may further include delivering the torque from the engine and the first electric machine to wheels of only the first axle and delivering the torque from the second electric machine to wheels of only the second axle. The method may also include delivering the torque from the engine through a planetary gear set to the first axle. In one embodiment, the method includes coupling a third electric machine to the first axle through the planetary gear set. The method may include controlling the torque delivered by the engine and the first and second electric machines by controlling the second machine torque based on retrieving a target torque from a lookup table stored in memory accessible by the vehicle controller indexed by a difference between the driver demand torque and the engine torque. The method may further include controlling the torque delivered by the first electric machine to wheels of the first axle based on the torque delivered by the second electric machine to the second axle.

Embodiments of the disclosure may provide one or more associated advantages. For example, one or more embodiments of a vehicle or method according to the disclosure optimize powertrain efficiency without complex runtime calculations to determine the torque allocation among the engine and electric machines. The allocation of electric machine torque does not sacrifice all-wheel drive features with full AWD capability available on demand. Constraining torque for the secondary axle electric machine(s) to zero or greater ensures that the primary and secondary axle electric machines deliver torque in the same direction to maintain vehicle stability. Those of ordinary skill in the art may recognize one or more additional advantages based on the representative embodiments described with reference to the corresponding figures.

### BRIEF DESCRIPTION OF THE DRAWINGS

FIG. 1 is a diagram illustrating an example of an electrified vehicle implemented as a PHEV (plug-in hybrid electric vehicle) having vehicle control to efficiently distribute powertrain torque to a secondary (rear) axle.

FIG. 2 is a diagram illustrating an example of an electrified vehicle implemented as a BEV (battery electric vehicle) having vehicle control to efficiently distribute powertrain torque to a secondary (front) axle.

FIG. 3 is a block diagram illustrating operation of an electrified vehicle or control method for efficiently distributing powertrain torque to a secondary axle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The processes, methods, or algorithms disclosed herein can be deliverable to/implemented by one or more processing devices, controllers, or computers, which can include any existing programmable electronic control unit or dedicated electronic control unit. Similarly, the processes, methods, or algorithms can be stored as data and instructions executable by a controller or computer in many forms including, but not limited to, information stored on volatile or persistent non-transitory storage media such as ROM devices and information alterably stored on writeable storage media such as FLASH devices, MRAM devices and other solid-state, magnetic, and/or optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers, or any other hardware components or devices, or a combination of hardware, software and firmware components.

The present inventors have recognized that, an electric all-wheel drive (eAWD) system has the freedom to allocate and distribute torque between the primary and secondary axles in various ways where the total of the primary axle and secondary axle torques equals the total driver-demanded torque. In addition, it is desirable to distribute this torque between both axles in the most efficient way possible to minimize fuel consumption and maximize electric range during operating conditions where full AWD operation is not needed. Furthermore, the losses generated by operating an electric motor vary as a function of speed and generated torque such that for a given vehicle speed it is desirable to select motor torques that minimize total electric losses. As such, various embodiments according to the disclosure provide a control system that determines the distribution of torque between the primary and secondary actuators that uses the least amount of electric power and is applied during times when the AWD system is not needed. In addition, the present inventors have recognized that under certain vehicle conditions of various prior art implementations, it is possible that torque allocations for engine torque may result in a negative torque for one or more electric machines in a hybrid eAWD application, which may lead to vehicle instability. As such, embodiments according to this disclosure ensure that the torque applied to each axle is in the same direction.

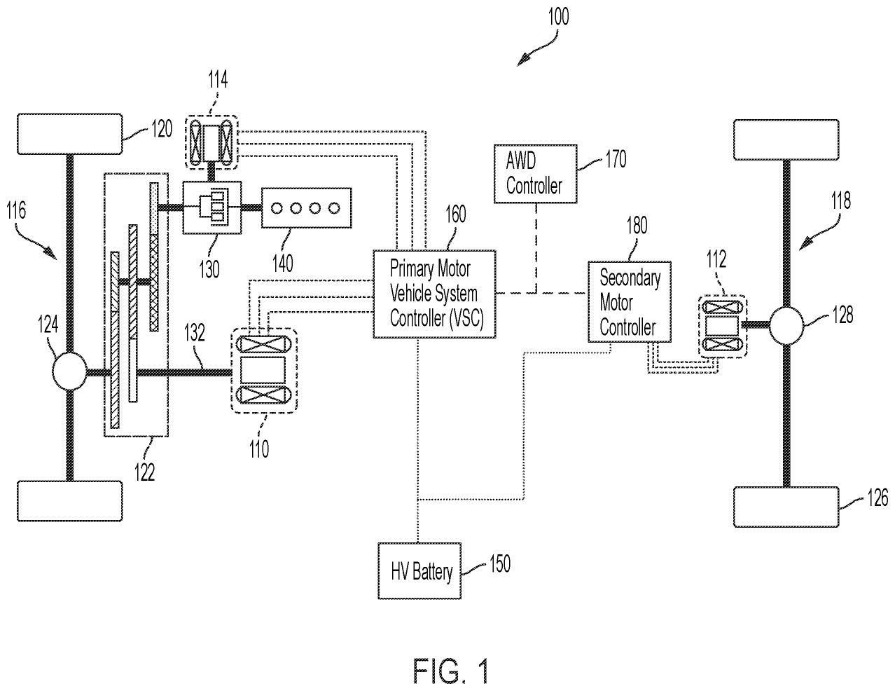

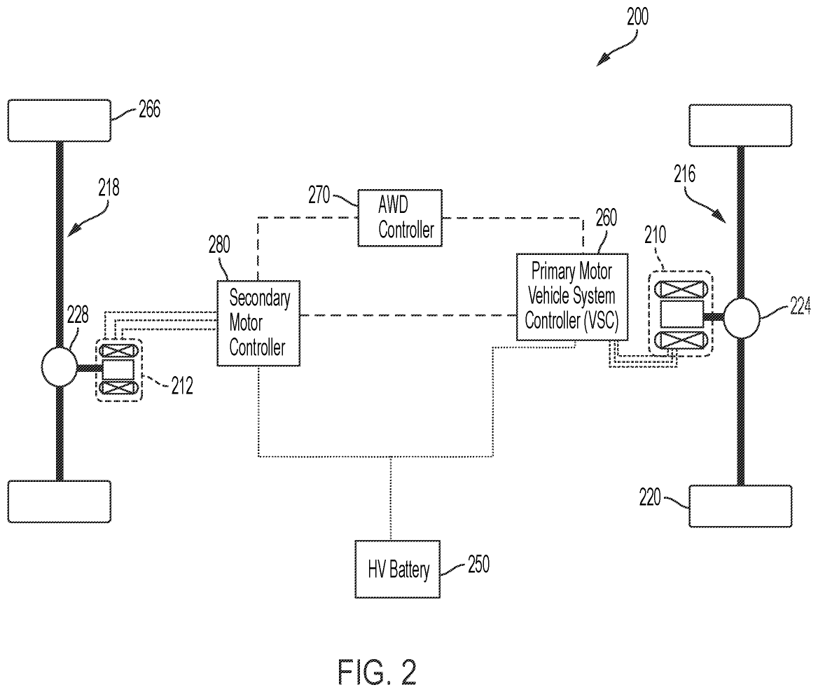

In the schematic block diagrams of FIGS. 1 and 2, a thick solid line generally represents a mechanical connection, a thin solid line represents a high-voltage AC electrical connection, a dotted line generally represents a high-voltage DC electrical connection, and a dashed line represents a wired or wireless vehicle network connection, such as a controller area network (CAN) connection. While representative connections are illustrated, the simplified illustrations are not exhaustive and other connections may exist for various applications or implementations that are not explicitly illustrated or described.

In the representative embodiment of FIG. 1, vehicle 100 is an electrified vehicle, such as a plug-in hybrid electric vehicle (HEV) in this example, but may also be a fully electrified battery electric vehicle 200 (BEV) as illustrated in FIG. 2, or other type of electrified vehicle depending on the particular implementation. Vehicle 100 may comprise one or more electric machines 110, 112, 114 mechanically coupled or connected to a primary axle 116 and/or a secondary axle 118. A first electric machine 110 is mechanically connected to the front wheels 120 of primary axle 116 through a transmission 122 and differential 124. A second electric machine 112 is mechanically connected to the rear wheels 126 of secondary axle 118 via a differential 128. A third electric machine 114 is mechanically coupled to primary axle 116 in parallel with electric machine 110 through a planetary gearset 130 mechanically connected to transmission 122, which is mechanically connected to differential 124. The electric machines 110, 112, 114 may be capable of operating as a motor or a generator. Electric machines 110, 112 operate primarily as motors to provide propulsive torque to front and rear wheels 120, 126 but may also operate as generators during regenerative braking. Electric machine 114 operates primarily as a generator to manage speed of internal combustion engine 140 and charge high-voltage (HV) traction battery 150, but may also operate as a motor to provide cranking torque to engine 140 or propulsive torque to primary/front wheels 120.

Transmission 122 is mechanically connected to internal combustion engine 140 via planetary gearset 130. The transmission 122 is also mechanically connected to a drive shaft 132 that is mechanically connected to the wheels 120. The electric machines 110, 112, 114 can provide propulsion and regenerative braking capability when the engine 140 is turned on or off. During regenerative braking, one or more of the electric machines 110, 112, 114 operate as generators and can provide fuel economy benefits by recovering energy that would normally be lost as heat in the friction braking system. The electric machines 110, 112, 114 may also reduce vehicle emissions by allowing the engine 140 to operate at more efficient rotational speeds and allowing the hybrid-electric vehicle 100 to be operated in electric mode with the engine 140 off under certain conditions.

A high-voltage traction battery or battery pack 150 includes a plurality of low voltage cells connected in groups or strings to provide a desired energy storage capacity and output voltage/current that can be used by the electric machines 110, 112, 114 when operating as motors, and transferred/stored when operating as generators. A battery pack 150 typically provides a high-voltage DC output that may be converted to a three-phase AC current using associated electronic circuitry to interface with the electric machines 110, 112, 114. Traction battery pack 150 may include an associated battery energy control module (BECM) in communication with one or more vehicle controllers, such as a vehicle system controller (VSC) 160 and AWD controller 170 over a wired or wireless vehicle network.

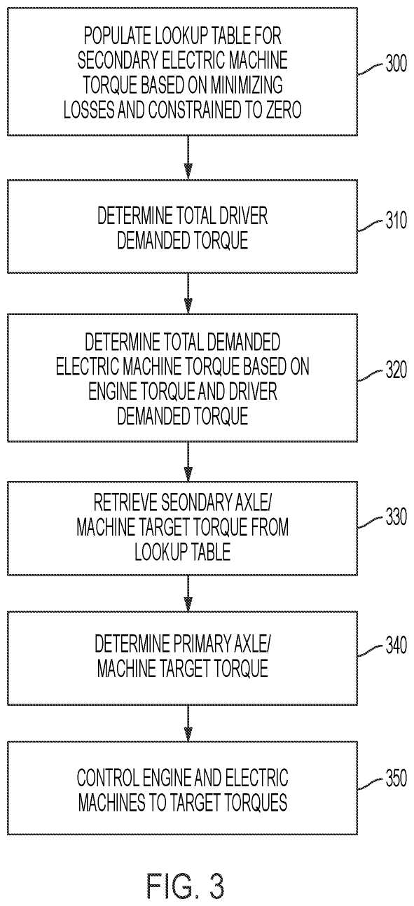

Each vehicle controller may include a processor in communication with one or more non-transitory computer readable storage media or memories that store data and instructions executable by the processor to control one or more associated components or systems. Data may be organized in an array or lookup table accessible by one or more index variables or parameters. In one embodiment, at least one vehicle controller accesses a memory including a lookup table having values for secondary electric machine torque indexed based on a total electric machine torque, which corresponds to a sum of primary and secondary electric machine torque. The lookup table may include only target torque values that are greater than zero. In one embodiment, the target torque values are determined based on the design characteristics of the primary axle 116 and secondary axle 118 and calculated for the most efficient value for torque of secondary electric machine 112 for any given total electric demand torque and vehicle speed. The target values may be calculated by iterating over a range of total electric torque and vehicle speed operating points and then calculating total losses for a range of possible combinations of target torques for primary electric machine 110 and secondary electric machine 112. One strategy for determining target values is described in commonly owned US The resulting values stored in the lookup table in memory are constrained such that primary axle torque applied to primary axle 116 is in the same direction as secondary axle torque applied to secondary axle 118. During operation vehicle operation, the VSC 160 can access the previously stored lookup table to determine the optimal primary and secondary axle torques provided by primary electric machine 110 and secondary electric machine 112 to meet the current driver demand at the current vehicle speed as described in greater detail with reference to FIG. 3.

In addition to providing energy for propulsion, the traction battery 150 may provide energy for other vehicle electrical systems including an HV compressor or heater, for example. A typical system may include a DC/DC converter module that converts the HV DC output of the traction battery 150 to a low voltage DC supply that is compatible with other low-voltage vehicle accessories. The low-voltage systems may be electrically connected to an auxiliary battery (e.g., 12V, 24V, or 48V battery).

The electrified vehicle 100 may be a plug-in hybrid vehicle (PHEV) in which the traction battery 150 may be recharged by an external power source, such as a power utility grid, or may be a standard hybrid that charges traction battery 150 from operating one or more electric machines 110, 112, 114 as a generator, but does not receive power from an external power source. The external power source may be connected by an electrical cord or via wireless charging, which may be referred to as hands-free or contactless charging, that uses inductive or similar wireless power transfer.

The various components described as well as additional components that are not explicitly illustrated or described may have one or more associated controllers to control and monitor the operation of the components. The controllers may communicate via a vehicle network that may be implemented as a serial bus (e.g., Controller Area Network (CAN)) or via discrete conductors. In addition, VSC 160 may coordinate the operation of the various components and may communicate directly or indirectly with one or more other vehicle controllers, such as AWD controller 170, secondary axle motor controller 180, a BECM, a body controller, and a battery charger controller or control module, for example.

As generally illustrated by the simplified block diagram of FIG. 1, an electrified vehicle 100 includes an engine 140 configured to selectively apply propulsive torque to wheels 120 of a first axle 116 of the vehicle 100. A first electric machine 110 is configured to selectively apply propulsive torque to the wheels 120 of the first axle 116 of the vehicle 100. A second electric machine 112 is configured to selectively apply propulsive torque to wheels 126 of a second axle 118 of the vehicle 100. A traction battery 150 is electrically coupled to the first electric machine 110 and the second electric machine 112. A controller 160 is configured to control speed and torque of engine 140, speed and torque of first electric machine 110, and speed and torque of second electric machine 112 to provide a driver demand torque at the wheels 120, 126 of the first axle 116 and second axle 118. As described in greater detail with respect to FIG. 3, one or more controllers 160, 170, 180 allocate torque between the first and second electric machines 110, 112 and engine 140 based on associated combined losses of the first and second electric machines 110, 112 and maintaining the torque of the first and second electric machines 110, 112 in the same direction, i.e. both positive or both negative. In one or more embodiments, one or more controllers 160, 170, 180 control the second electric machine 112 to deliver torque greater than or equal to zero in response to a target value retrieved from a lookup table stored in memory accessible by the controller. The lookup table may be indexed by one or more vehicle operating parameters, such as engine torque, driver demand torque, total electric machine torque, etc.

FIG. 2 depicts a possible configuration for an electrified vehicle 200 implemented as a battery-electric vehicle (BEV). Vehicle 200 includes a primary electric machine 210 powered by an HV traction battery 250 and mechanically coupled to a primary axle 216 via a corresponding primary gearbox or differential 224 to provide propulsive torque to primary axle wheels 220. A secondary electric machine 212 also powered by HV traction battery 250 is mechanically coupled to a secondary axle 218 via corresponding secondary gearbox or differential 228 to provide propulsive torque to secondary axle wheels 226. In contrast to the configuration illustrated in FIG. 1 having the front axle as the primary axle 116 and the rear axle as the secondary axle 118, the BEV configuration of FIG. 2 has the rear axle as the primary axle 216 and the front axle as the secondary axle 218. The primary and secondary axles and related components may be designated based on the relative power output of the associated electric machines with the primary electric machine having higher power output capability than the secondary electric machine. Other configurations are possible with the primary and secondary electric machines having the same nominal power output capability. Likewise, although a BEV is depicted, other electric-drive configurations are possible. For example, the vehicle may be a fuel-cell vehicle. The fuel-cell vehicle may include a fuel cell as a primary energy source while the traction battery 250 acts as a secondary energy source. The fuel-cell vehicle may be a plug-in type that permits recharging of the traction battery 250 by an external power source. The implementations described herein may be applicable to any vehicles that include an electric-drive having multiple electric machines.

The vehicles 100, 200 of FIGS. 1 and 2 may be characterized as electric all-wheel drive (eAWD) vehicles. Having an electric machine configured to deliver propulsive torque independently to wheels of an associated axle allows operation in different modes based on operating conditions. For example, at different times, the vehicle may function as a RWD vehicle, a FWD vehicle, or and AWD vehicle. Such a powertrain allows performance to be optimized. Stability and acceleration may be improved by selecting a particular mode of operation and associated control of the electric machines by one or more of the primary motor vehicle system controller 160, 260, AWD controller 170, 270, and secondary motor controller 180, 280. The controllers of the eAWD system allocate and distribute torque between the primary and secondary axles such that the total of the primary axle and secondary axle torques equals the total driver-demanded torque. The losses generated by operating an electric machine vary as a function of speed and generated torque such that for a given vehicle speed it is desirable to select target values for the electric machine torques that minimize total electric losses to minimize fuel consumption (for hybrid applications) and maximize electric range during times when full AWD is not needed. The controllers distribute this torque between both axles based on values stored in one or more lookup tables that include empirically or otherwise determined values to minimize losses of the electric machines, while ensuring that torque is applied in the same direction by constraining values for the secondary electric machine to be greater than or equal to zero.

FIG. 3 illustrates operation of a system or method for controlling an electrified vehicle to allocate torque between primary and secondary electric machines to minimize losses while ensuring target torques in the same direction. The control logic, functions, or algorithms performed in whole or in part by one or more of controllers 160, 170, 180 or other controllers of the vehicle may be represented by the simplified flow chart of FIG. 3. This illustration provides a representative control strategy, algorithm, and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle, engine, electric machine, and/or powertrain controller. The control logic may be implemented in software, hardware, or a combination of software and hardware in one or more controllers depending upon the particular application. When implemented in software, the control logic may be provided in one or more non-transitory computer-readable storage devices or media having stored data representing code or instructions executed by a computer to control the vehicle or its subsystems. The computer-readable storage devices or media may include one or more of a number of known physical devices which utilize solid-state, electric, magnetic, and/or optical storage to keep executable instructions and associated calibration information, operating variables, and the like.

Total delivered wheel torque is made up of three components: primary axle electric machine torque (τ_{mot_p}), secondary axle electric machine torque (τ_{mot_s}), and output torque from the planetary gearbox due to engine power (τ_{eng}). For embodiments that do not include an internal combustion engine, the engine power can be omitted or considered as zero. The total demanded driver torque may be determined using known strategies based on inputs such as vehicle speed, accelerator pedal position, cruise control status, etc. The total driver-demanded torque (τₜₒₜ) may be represented as:

τₜₒₜ=τ_{eng}+τ_{mot_p}+τ_{mot_s}

A total demanded electric machine torque (τ_{tot_elec}) can then be calculated according to:

τ_{tot_elec}=τₜₒₜ−τ_{eng}=τₘₒₜ_{ₚ}+τₘₒₜ_{ₛ} (1)

To ensure vehicle stability, the torque applied to each axle should be in the same direction. In certain vehicle conditions, it is possible that τ_{eng} is greater than τₜₒₜ which could cause a negative τ_{tot_elec} while τₜₒₜ is positive. According to various embodiments of the present disclosure, in this case τ_{mot_s} is constrained to zero and the vehicle controller(s) will allocate all of the electric machine torque to the primary axle (i.e. τ_{mot_p}=τ_{tot_elec}).

Based on the design characteristics of the primary axle and secondary axle, a lookup table stored in memory accessible by the vehicle controller(s) is populated with values corresponding to a desired efficiency value for τ_{mot_s} for any given τ_{tot_elec} and vehicle speed as represented at 300 in FIG. 3. These values can be calculated by iterating over a range of τ_{tot_elec} and vehicle speed operating points and then calculating total losses for a range of possible combinations of τ_{mot_s} and τ_{mot_p} to determine the desired optimal value of τ_{mot_s}. The results of this table are constrained such that primary axle torque is applied in the same direction as secondary axle torque. In one embodiment, results are constrained such that the secondary axle torque is greater than or equal to zero.

During vehicle operation, the vehicle controller(s) determine a total driver demanded torque as represented at 310. A corresponding total demanded electric torque is then determined based on engine torque according to equation (1) for current engine operating conditions as represented at 320. The controller(s) retrieves a corresponding target value from the previously stored lookup table for the secondary axle torque to control the secondary electric machine as represented at 330. The primary axle target torque to control the primary electric machine is then calculated at 340 according to:

τ_{mot_p}=τ_{tot_elec}−τ_{mot_s}.

The controller(s) then control the engine and the primary and secondary electric machines to deliver the associated target torques to allocate the total electric machine torque between the primary and secondary axles as represented at 350.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
an engine configured to selectively apply propulsive torque to wheels of a first axle of the vehicle;
a first electric machine configured to selectively apply propulsive torque to the wheels of the first axle of the vehicle;
a second electric machine configured to selectively apply propulsive torque to wheels of a second axle of the vehicle;
a traction battery electrically coupled to the first and second electric machines; and
a controller configured to control engine torque, first electric machine torque, and second electric machine torque to provide a driver demand torque at the wheels of the first and second axles, wherein the controller allocates torque between the first and second electric machines based on associated combined losses of the first and second electric machines and maintaining the torque of the first and second electric machines in the same direction.

2. The vehicle of claim 1 wherein the controller is further configured to control the second electric machine torque based on a difference between the driver demand torque and the engine torque, and to control the first electric machine torque based on the second electric machine torque.

3. The vehicle of claim 2 wherein the controller is further configured to retrieve a target value for the second electric machine torque from a lookup table stored in memory accessible by the controller and indexed based on a total electric machine torque, the total electric machine torque corresponding to a difference between the driver demand torque and the engine torque.

4. The vehicle of claim 3 wherein the controller is further configured to control the first electric machine torque based on a difference between the total electric machine torque and the target value for the second electric machine torque.

5. The vehicle of claim 3 wherein the lookup table includes only target values greater than zero.

6. The vehicle of claim 1 further comprising a transmission having a plurality of gears connecting both the engine and the first electric machine to the first axle.

7. The vehicle of claim 6 further comprising a planetary gear set connecting the engine to the transmission, wherein the engine torque is adjusted based on a torque ratio of the planetary gear set.

8. The vehicle of claim 6 further comprising a third electric machine connected to the planetary gear set and electrically connected to the traction battery.

9. A system comprising:
a first electric machine configured to provide torque to at least one wheel of a primary axle;
a second electric machine configured to provide torque to at least one wheel of a secondary axle; and
a controller programmed to control torque of the first and second electric machines to deliver a driver demand torque to at least one of the primary and secondary axle wheels based on combined power loss associated with torque delivered by the first and second electric machines, wherein the torque delivered by the first and second electric machines is in the same direction.

10. The system of claim 9 wherein the controller is further programmed to control the second electric machine to deliver torque greater than or equal to zero.

11. The system of claim 9 wherein the controller is further programmed to control the second electric machine torque in response to a target value retrieved from a lookup table stored in memory accessible by the controller, the lookup table indexed by the driver demand torque.

12. The system of claim 9 further comprising an engine configured to deliver engine torque to the at least one wheel of the primary axle, wherein the controller controls the torque delivered by the first and second electric machines in response to a difference between the driver demand torque and the engine torque.

13. The system of claim 12 further comprising a third electric machine, wherein the engine and the third electric machine are coupled to the at least one wheel of the primary axle through a planetary gear set.

14. The system of claim 13 wherein the controller determines the driver demand torque in response to an accelerator pedal position, determines the second electric machine torque from a lookup table based on a difference between the driver demand torque and the engine torque, and determines the first electric machine torque based on the second electric machine torque and the difference between the driver demand torque and the engine torque.

15. A method comprising, by a vehicle controller:
controlling torque delivered by an engine and first and second electric machines to wheels of a first and second axle to meet a driver demand torque such that torque delivered by the first and second electric machines is allocated based on torque-related losses of the first and second electric machines, and such that the torque delivered by the second electric machine is greater than or equal to zero.

16. The method of claim 15 further comprising delivering the torque from the engine and the first electric machine to wheels of only the first axle and delivering the torque from the second electric machine to wheels of only the second axle.

17. The method of claim 16 further comprising delivering the torque from the engine through a planetary gear set to the first axle.

18. The method of claim 17 further comprising coupling a third electric machine to the first axle through the planetary gear set.

19. The method of claim 18 wherein controlling the torque delivered by the engine and the first and second electric machines comprises controlling the second electric machine torque in response to a target torque from a lookup table stored in memory accessible by the vehicle controller based on a difference between the driver demand torque and the engine torque.

20. The method of claim 19 further comprising controlling the torque delivered by the first electric machine to wheels of the first axle based on the torque delivered by the second electric machine to wheels of the second axle.
